(19) United States
(12) Patent Application Publication
(10) Pub. No.: US 2025/0236492 A1
(43) Pub. Date: Jul. 24, 2025

(54) GANTRY-TYPE SLAB TRANSFER DEVICE

(71) Applicant: VEEGOO TECHNOLOGY CO., LTD., Foshan (CN)

(72) Inventors: Zhongyuan LI, Foshan (CN); Yonglin TANG, Foshan (CN); Luyang TONG, Foshan (CN); Hexing WEN, Foshan (CN)

(21) Appl. No.: 19/060,862

(22) Filed: Feb. 24, 2025

Related U.S. Application Data
(63) Continuation of application No. PCT/CN2025/078033, filed on Feb. 19, 2025.

(30) Foreign Application Priority Data
Jun. 13, 2024 (CN) 202421355691.2

(51) Int. Cl. B66C 17/06; B66C 1/34

(52) U.S. Cl. CPC B66C 17/06; B66C 1/34

(57) ABSTRACT

A gantry-type slab transfer device, including a moving frame, a mounting frame, a lifting mechanism, a hooking mechanism, a moving mechanism and two gantry frames. A discharging station, a feeding station and a processing station are arranged between the two gantry frames. The moving mechanism is provided at the moving frame, and is configured to drive two ends of the moving frame to move along the two gantry frames, respectively. The lifting mechanism is mounted on the moving frame. The mounting frame is liftably mounted to the moving frame through the lifting mechanism. The hooking mechanism is arranged at the mounting frame, and is configured to hook a grid frame.

### CROSS-REFERENCE TO RELATED APPLICATIONS

This application is a continuation of International Patent Application No. PCT/CN2025/078033, filed on Feb. 19, 2025, which claims the benefit of priority from Chinese Patent Application No. 202421355691.2, filed on Jun. 13, 2024. The content of the aforementioned application, including any intervening amendments thereto, is incorporated herein by reference in its entirety.

### TECHNICAL FIELD

This application relates to artificial stone slab processing equipment, and more particularly to a gantry-type slab transfer device.

### BACKGROUND

Before installing an artificial stone slab on a cabinet or a bathroom countertop, it is required to use a waterjet cutting machine to form sink or basin installation holes in the slab, and to trim the edges or corners, so as to make the shape and dimensions of the slab meet the on-site installation requirements, thereby eliminating the need for additional processing at the installation site and improving installation efficiency and quality.

In the existing waterjet cutting systems, the to-be-processed slabs are manually transferred from a feeding station to a processing station of the waterjet cutting machine for cutting, and then the processed slabs are manually transferred from the processing station to a discharge station. Such a process not only increases the labor intensity of operators, but also reduces the waterjet processing efficiency.

### SUMMARY

In view of this, an object of the present disclosure is to provide a gantry-type slab transfer device, which eliminates the need for manual handling of slabs or grid frames, thereby reducing the labor intensity and improving the processing efficiency.

Technical solutions of the present disclosure are described as follows.

A gantry-type slab transfer device, comprising:
a moving frame;
a mounting frame;
a lifting mechanism;
a hooking mechanism;
a moving mechanism; and
two gantry frames;
wherein the two gantry frames are each configured to laterally extend; the two gantry frames are arranged spaced apart from each other; and a discharging station, a feeding station and a processing station are arranged between the two gantry frames;
the moving mechanism is provided at the moving frame, and is configured to drive two ends of the moving frame to move along the two gantry frames, respectively;
the lifting mechanism is mounted on the moving frame; and the mounting frame is liftably mounted to the moving frame through the lifting mechanism; and
the hooking mechanism is arranged at the mounting frame, and is configured to hook a grid frame located at the discharging station, the feeding station or the processing station.

In some embodiments, the hooking mechanism comprises a plurality of hooks and a plurality of hook drivers;
the plurality of hooks are in one-to-one correspondence with the plurality of hook drivers;
the plurality of hook drivers are mounted on the mounting frame; a middle portion of each of the plurality of hooks is rotatably mounted on an outer side surface of the mounting frame;
a top end of each of the plurality of hooks is connected to an output end of a corresponding one among the plurality of hook drivers; and
a bottom end of each of the plurality of hooks is configured to hook a border of the grid frame.

In some embodiments, the gantry-type slab transfer device further comprises a pressing mechanism;
wherein the pressing mechanism comprises a plurality of drivers and a pressing frame;
the pressing frame is embeddedly provided at a bottom portion of the mounting frame; the plurality of drivers are mounted on a top surface of the mounting frame; an output end of each of the plurality of drivers is configured to extend downward to be connected to a top surface of the pressing frame; and
a bottom surface of the pressing frame is configured to abut against a top surface of a to-be-transferred slab placed on the grid frame.

In some embodiments, the lifting mechanism comprises a lifting column, a motor, a guiding column, a transmission shaft, a transmission gear and a transmission chain;
the guiding column has a hollow structure, and is vertically embedded at a middle portion of the moving frame;
the motor and the transmission shaft are mounted on a first side surface of the guiding column; an output end of the motor is in transmission connection with an outer peripheral surface of a first end of the transmission shaft; and the transmission gear is sleeved on an outer peripheral surface of a second end of the transmission shaft;
a lower end of the lifting column is connected to the top surface of the mounting frame; and an upper end of the lifting column is configured to extend upward through the guiding column to protrude out of a top surface of the guiding column;
two ends of the transmission chain are fixed to a side surface of the lifting column; and
the transmission gear is engaged with the transmission chain.

In some embodiments, the lifting mechanism further comprises a plurality of guiding wheel sets;
each of the plurality of guiding wheel sets is composed of two guiding wheels; the two guiding wheels are arranged spaced apart vertically, and are rotatably mounted on a second side surface of the guiding column; and
an outer peripheral surface of each of the two guiding wheels is configured to extend inward through an inner wall of the guiding column to be in frictional contact with a corresponding outer side surface of the lifting column.

In some embodiments, an outer side surface of the lifting column is further provided with a plurality of limiting columns;
the plurality of limiting columns are provided adjacent to a top portion of the outer side surface of the lifting column, or adjacent to a bottom portion of the outer side surface of the lifting column;
the first side surface of the guiding column is provided with a plurality of limiting plates in one-to-one correspondence with the plurality of limiting columns;
the plurality of limiting plates are provided adjacent to a top portion of the first side surface of the guiding column, or adjacent to a bottom portion of the first side surface of the guiding column;
a surface of each of the plurality of limiting plates is configured to abut against a bottom surface or a top surface of a corresponding one among the plurality of limiting columns; and
those of the plurality of limiting columns located at the top portion of the outer side surface of the lifting column are provided adjacent to an upper end of the transmission chain, and those of the plurality of limiting columns located at the low portion of the outer side surface of the lifting column are provided adjacent to a lower end of the transmission chain.

In some embodiments, the lifting mechanism further comprises at least two auxiliary gears;
the at least two auxiliary gears are mounted on a second side surface of the guiding column, and are adjacent to an upper portion or a lower portion of the transmission gear;
the at least two auxiliary gears are engaged with the transmission chain; and
the transmission gear is provided between the at least two auxiliary gears.

Compared to the prior art, the present disclosure has the following beneficial effects.

The gantry-type slab transfer device utilizes the grid frame as a turnover tool for to-be-transferred slabs. By means of the cooperation between the lifting mechanism, the hooking mechanism, and the moving mechanism with the moving frame and the mounting frame, the device provided herein can perform feeding of to-be-transferred slabs from the feeding station to the processing station, discharging of the to-be-transferred slabs from the processing station to the discharging station, and transferring of the grid frame from the discharging station to the feeding station, where the processing station, the discharging station and the feeding station are located between the two gantry frames. This configuration eliminates the need for manual handling of the to-be-transferred slabs or grid frames, thereby reducing operator labor intensity and improving the processing efficiency. Furthermore, the lifting mechanism provides increases the available space for picking and placing the grid frame in a vertical direction, enabling flexible arrangement of the feeding station, the processing station and the discharging station between the two gantry frames.

### BRIEF DESCRIPTION OF THE DRAWINGS

FIG. 1 is a structural diagram of a gantry-type slab transfer device according to an embodiment of the present disclosure;

FIG. 2 schematically shows an assembly structure of a moving frame and a part of a lifting mechanism according to an embodiment of the present disclosure;

FIG. 3 schematically shows an assembly structure of a mounting frame and another part of the lifting mechanism according to an embodiment of the present disclosure; and

FIG. 4 is an enlarged view of portion “A” in FIG. 2.

In the figures: 1—gantry frame; 2—moving frame; 3—mounting frame; 4—lifting mechanism; 5—hooking mechanism; 6—pressing mechanism; 7—moving mechanism; 41—lifting column; 42—motor; 43—guiding column; 44—transmission shaft; 45—transmission gear; 46—transmission chain; 47—guiding wheel; 48—auxiliary gear; 51—hook; 52—first driver; 61—second driver; 62—pressing frame; 411—limiting column; and 431—limiting plate.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

As used herein, it should be noted that, unless otherwise expressly specified or limited, the terms “mounted” and “connected” should be interpreted in a broad sense. For example, the connection can be a fixed connection, a detachable connection, or an integral connection; it can be a mechanical connection, or an electrical connection; it can be a direct connection, an indirect connection through an intermediate medium, or an internal communication between two components. The specific meaning of these terms in the present disclosure can be understood by those skilled in the art based on the particular circumstances.

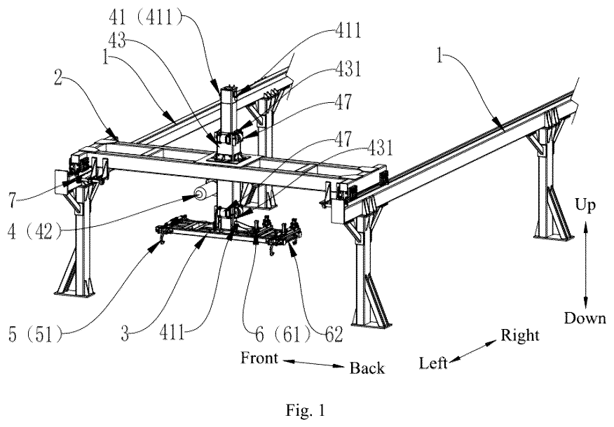

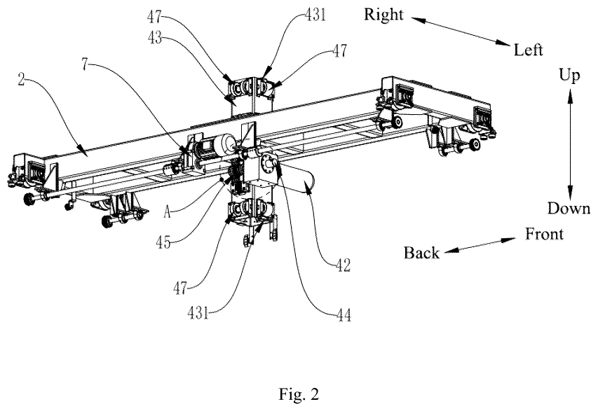

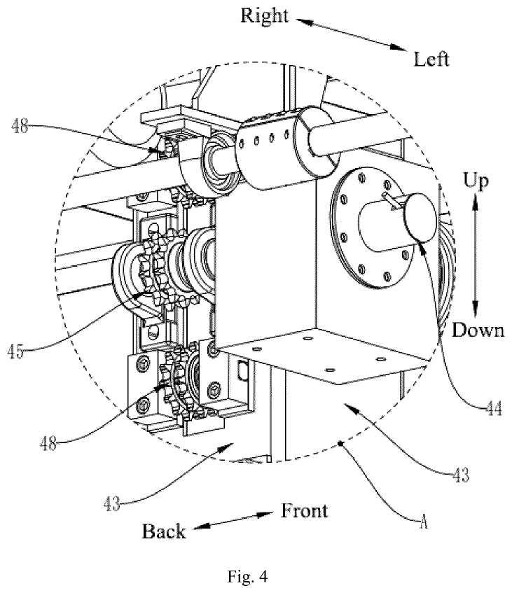

As shown in FIGS. 1-4, an embodiment of the present disclosure provides a gantry-type slab transfer device, including a moving frame 2, a mounting frame 3, a lifting mechanism 4, a hooking mechanism 5, a moving mechanism 7 and two gantry frames 1. The two gantry frames 1 are each configured to extend in a left-right direction. The two gantry frames 1 are arranged spaced apart from each other in a front-to-back direction. A discharging station, a feeding station and a processing station are arranged between the two gantry frames 1. The moving mechanism 7 is provided at the moving frame 2, and is configured to drive left and right ends of the moving frame 2 to move along the two gantry frames 1, respectively. The lifting mechanism 4 is mounted on the moving frame 2. The mounting frame 3 is liftably mounted to the moving frame 2 through the lifting mechanism 4. The hooking mechanism 5 is arranged at the mounting frame 3, and is configured to hook a grid frame located at the discharging station, the feeding station or the processing station.

The grid frame is configured to support to-be-processed slabs or slabs that have been processed.

As shown in FIG. 1, the discharging station located in a slab discharging system, the feeding station located in a slab feeding system, and the processing station located in a waterjet cutting machine are arranged between the two gantry frames 1. The grid frame is provided at the slab feeding station, and a to-be-processed slab is transported onto a top surface of the grid frame through the slab feeding system. After the to-be-processed slab is positioned, the gantry-type slab transfer device provided herein can be used to transfer the to-be-processed slab from the feeding station to the processing station. The operational steps are as follows. The moving mechanism 7 drives the moving frame 2 to move along the two gantry frames 1, thereby synchronously moving the mounting frame 3, the lifting mechanism 4 and the hooking mechanism 5, such that the mounting frame 3 is positioned above the feeding station. Then, the lifting mechanism 4 lowers the mounting frame 3, allowing a bottom surface of the mounting frame 3 to approach a top surface of the to-be-processed slab. Subsequently, the hooking mechanism 5 hooks the grid frame below the mounting frame 3. Next, the lifting mechanism 4 lifts the mounting frame 3, the to-be-processed slab and the grid frame together. The moving mechanism 7 drives the moving frame 2 to move along the two gantry frames 1 again, thereby synchronously moving the mounting frame 3, the lifting mechanism 4 and the hooking mechanism 5, such that the mounting frame 3 is positioned above the processing station. The lifting mechanism 4 further lowers the mounting frame 3, thereby placing the grid frame at the processing station. After the hooking mechanism 5 is released, the lifting mechanism 4 lifts the mounting frame 3, thereby separating the mounting frame 3 from the to-be-processed slab and the grid frame. At this point, the waterjet cutting machine can be activated to process the to-be-processed slab.

When the processing of to-be-processed slab is completed, the gantry-type slab transfer device provided herein is used to transfer the processed slab to the discharging station. The operation steps are as follows. The moving mechanism 7 drives the moving frame 2 to move along the two gantry frames 1, thereby synchronously moving the mounting frame 3, the lifting mechanism 4 and the hooking mechanism 5, such that the mounting frame 3 is positioned above the processing station. Then, the lifting mechanism 4 lowers the mounting frame 3, allowing the bottom surface of the mounting frame 3 to approach a top surface of the processed slab. The hooking mechanism 5 hooks the grid frame below the mounting frame 3. Next, the lifting mechanism 4 lifts the mounting frame 3, the processed slab and the grid frame together. The moving mechanism 7 drives the moving frame 2 to move along the gantry frames 1 again, thereby synchronously moving the mounting frame 3, the lifting mechanism 4 and the hooking mechanism 5, such that the mounting frame 3 is positioned above the discharging station. The lifting mechanism 4 further lowers the mounting frame 3, placing the grid frame at the discharging station. After the hooking mechanism 5 is released, the lifting mechanism 4 lifts the mounting frame 3, thereby separating the mounting frame 3 from the processed slab and the grid frame. At this point, the slab discharging system can be activated to transport the processed slab above the grid frame away, thereby completing the slab discharging process.

Subsequently, the grid frame can be transferred from the discharging station to the feeding station by referring to the above steps, thereby completing a full cycle of slab feeding, processing and discharging.

Throughout the above operations, there is no need for manual handling of slabs or grid frames, which reduces the labor intensity of operators and improves the processing efficiency. Additionally, the lifting mechanism 4 increases the available space for picking and placing the grid frame in a vertical direction, enabling flexible arrangement of the discharging station, feeding station and processing station between the two gantry frames 1.

In some embodiments, the hooking mechanism 5 includes a plurality of hooks 51 and a plurality of first drivers 52. The plurality of hooks 51 are in one-to-one correspondence with the plurality of first drivers 52. The plurality of first drivers 52 are mounted on the mounting frame 3. A middle portion of each of the plurality of hooks 51 is rotatably mounted on an outer side surface of the mounting frame 3. A top end of each of the plurality of hooks 51 is connected to an output end of a corresponding one among the plurality of first drivers 52. And a bottom end of each of the plurality of hooks 51 is configured to hook a border of the grid frame.

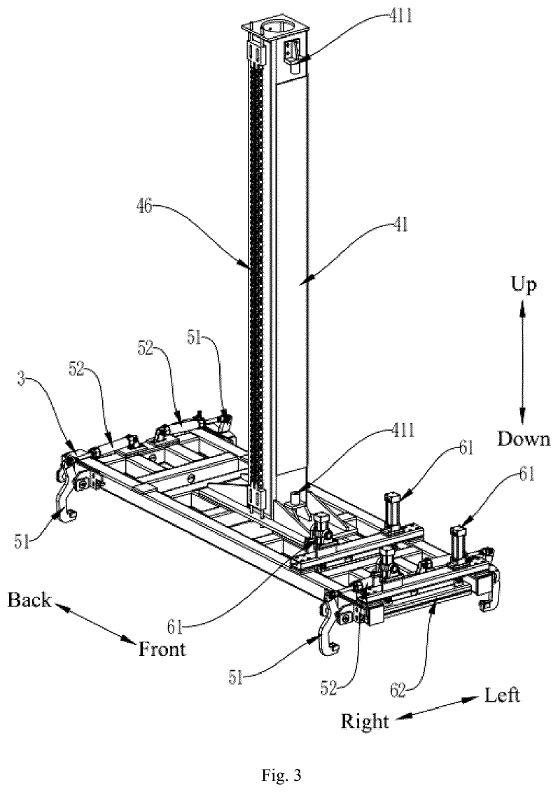

As shown in FIGS. 1 and 3, each of the plurality of first drivers 52 is configured to drive the corresponding hook 51 to open or close, thereby enabling the bottom end of the hook 51 to hook or release the border of the grid frame.

In some embodiments, the gantry-type slab transfer device provided herein further includes a pressing mechanism 6. The pressing mechanism 6 includes a plurality of second drivers 61 and a pressing frame 62. The pressing frame 62 is embeddedly provided at a bottom portion of the mounting frame 3. The plurality of second drivers 61 are mounted on a top surface of the mounting frame 3. An output end of each of the plurality of second drivers 61 is configured to extend downward to be connected to a top surface of the pressing frame 62. A bottom surface of the pressing frame 62 is configured to abut against a top surface of a to-be-transferred slab placed on the grid frame.

As shown in FIGS. 1 and 3, when the to-be-transferred slab is placed on the grid frame hooked by the hooking mechanism 5, the plurality of second drivers 61 are synchronously activated, such that output ends of the plurality of second drivers 61 move downward to push the pressing frame 62 until the bottom surface of the pressing frame 62 abuts against the top surface of the to-be-transferred slab. In this way, the to-be-transferred slab can be securely pressed to prevent movement during the transfer process.

In some embodiments, the lifting mechanism 4 includes a lifting column 41, a motor 42, a guiding column 43, a transmission shaft 44, a transmission gear 45 and a transmission chain 46. The guiding column 43 has a hollow structure. The guiding column 43 is vertically embedded at a middle portion of the moving frame 2. The motor 42 and the transmission shaft 44 are mounted on a first side surface of the guiding column 43. An output end of the motor 42 is in transmission connection with an outer peripheral surface of a first end of the transmission shaft 44. The transmission gear 45 is sleeved on an outer peripheral surface of a second end of the transmission shaft 44. A lower end of the lifting column 41 is connected to the top surface of the mounting frame 3. An upper end of the lifting column 41 is configured to extend upward through the guiding column 43 to protrude out of a top surface of the guiding column 43. Upper and lower ends of the transmission chain 46 are fixed to a side surface of the lifting column 41. And the transmission gear 45 is engaged with the transmission chain 46.

As shown in FIGS. 1-3, when it is necessary to raise or lower the mounting frame 3, the motor 42 is activated. The motor 42 drives the transmission chain 46 to move up and down through the transmission shaft 44 and the transmission gear 45, thereby driving the lifting column 41 to move up or down within the guiding column 43, such that the mounting frame 3 follows the lifting column 41 to rise or descend.

In some embodiments, the lifting mechanism 4 further includes a plurality of guiding wheel sets. Each of the plurality of guiding wheel sets is composed of two guiding wheels 47. The two guiding wheels 47 are arranged spaced apart vertically, and are rotatably mounted on a second side surface of the guiding column 43. An outer peripheral surface of each of the two guiding wheels 47 is configured to extend inward through an inner wall of the guiding column 43 to be in frictional contact with a corresponding outer side surface of the lifting column 41.

As shown in FIGS. 1-3, when the lifting column 41 moves up or down within the guiding column 43, the outer side surface of the lifting column 41 drives the guiding wheel 47 to rotate. This configuration prevents rigid contact and friction between the inner wall of the guiding column 43 and the outer side surface of the lifting column 41, thereby extending the service life of both the lifting column 41 and the guiding column 43 while improving the stability of the lifting column 41 during its movement.

In some embodiments, an outer side surface of the lifting column 41 is further provided with a plurality of limiting columns 411. The plurality of limiting columns 411 are provided adjacent to a top portion of the outer side surface of the lifting column 41, or adjacent to a bottom portion of the outer side surface of the lifting column 41. The first side surface of the guiding column 43 is provided with a plurality of limiting plates 431. The plurality of limiting plates 431 are in one-to-one correspondence with the plurality of limiting columns 411. The plurality of limiting plates 431 are provided adjacent to a top portion of the first side surface of the guiding column 43, or adjacent to a bottom portion of the first side surface of the guiding column 43. A surface of each of the plurality of limiting plates 431 is configured to abut against a bottom surface or a top surface of a corresponding one among the plurality of limiting columns 411. Those of the plurality of limiting columns 411 located at the top portion of the outer side surface of the lifting column 41 are provided adjacent to an upper end of the transmission chain 46, and those of the plurality of limiting columns 411 located at the low portion of the outer side surface of the lifting column 41 are provided adjacent to a lower end of the transmission chain 46.

As shown in FIGS. 1-3, the travel range of the lifting column 41 in the vertical direction is restricted through the cooperation of the plurality of limiting columns 411 and the plurality of limiting plates 431.

In some embodiments, the lifting mechanism 4 further includes at least two auxiliary gears 48. The at least two auxiliary gears 48 are mounted on the second side surface of the guiding column 43. The at least two auxiliary gears 48 are provided adjacent to an upper portion or a lower portion of the transmission gear 45. The at least two auxiliary gears 48 are engaged with the transmission chain 46. And the transmission gear 45 is provided between the at least two auxiliary gears 48.

As shown in FIGS. 1, 2 and 4, when the motor 42 drives the transmission chain 46 to move upward or downward through the transmission shaft 44 and the transmission gear 45, two auxiliary gears 48 positioned above and below the transmission gear 45 are simultaneously driven to rotate by the transmission chain 46. The two auxiliary gears 48 positioned above and below the transmission gear 45 are configured to press the transmission chain 46 against the side surface of the lifting column 41, thereby preventing the transmission chain 46 from lifting off during the lifting or lowering of the lifting column 41. This configuration enhances the smooth operation of the transmission gear 45 and the transmission chain 46, thereby improving the operational stability of the lifting column 41.

The gantry-type slab transfer device is shown in FIGS. 1-4. By means of the cooperation between the lifting mechanism 4, the hooking mechanism 5, and the moving mechanism 7 with the moving frame 2 and the mounting frame 3, the device provided herein can perform feeding of to-be-transferred slabs from the feeding station to the processing station, discharging of the to-be-transferred slabs from the processing station to the discharging station, and transferring of the grid frame from the discharging station to the feeding station, where the feeding station, the processing station and the discharging station are located between the two gantry frames 1. This configuration eliminates the need for manual handling of the to-be-transferred slabs or grid frames, thereby reducing operator labor intensity and improving the processing efficiency. Furthermore, the lifting mechanism 4 provides increases the available space for picking and placing the grid frame in a vertical direction, enabling flexible arrangement of the feeding station, the processing station and the discharging station between the two gantry frames 1.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A gantry-type slab transfer device, comprising:
a moving frame;
a mounting frame;
a lifting mechanism;
a hooking mechanism;
a moving mechanism; and
two gantry frames;
wherein the two gantry frames are each configured to laterally extend; the two gantry frames are arranged spaced apart from each other; and a discharging station, a feeding station and a processing station are arranged between the two gantry frames;
the moving mechanism is provided at the moving frame, and is configured to drive two ends of the moving frame to move along the two gantry frames, respectively;
the lifting mechanism is mounted on the moving frame; and the mounting frame is liftably mounted to the moving frame through the lifting mechanism; and
the hooking mechanism is arranged at the mounting frame, and is configured to hook a grid frame located at the discharging station, the feeding station or the processing station.

2. The gantry-type slab transfer device according to claim 1, wherein the hooking mechanism comprises a plurality of hooks and a plurality of hook drivers;
the plurality of hooks are in one-to-one correspondence with the plurality of hook drivers;
the plurality of hook drivers are mounted on the mounting frame; a middle portion of each of the plurality of hooks is rotatably mounted on an outer side surface of the mounting frame;
a top end of each of the plurality of hooks is connected to an output end of a corresponding one among the plurality of hook drivers; and
a bottom end of each of the plurality of hooks is configured to hook a border of the grid frame.

3. The gantry-type slab transfer device according to claim 1, further comprising:
a pressing mechanism;
wherein the pressing mechanism comprises a plurality of drivers and a pressing frame;
the pressing frame is embeddedly provided at a bottom portion of the mounting frame; the plurality of drivers are mounted on a top surface of the mounting frame; an output end of each of the plurality of drivers is configured to extend downward to be connected to a top surface of the pressing frame; and
a bottom surface of the pressing frame is configured to abut against a top surface of a to-be-transferred slab placed on the grid frame.

4. The gantry-type slab transfer device according to claim 1, wherein the lifting mechanism comprises a lifting column, a motor, a guiding column, a transmission shaft, a transmission gear and a transmission chain;
the guiding column has a hollow structure, and is vertically embedded at a middle portion of the moving frame;
the motor and the transmission shaft are mounted on a first side surface of the guiding column; an output end of the motor is in transmission connection with an outer peripheral surface of a first end of the transmission shaft; and the transmission gear is sleeved on an outer peripheral surface of a second end of the transmission shaft;
a lower end of the lifting column is connected to the top surface of the mounting frame; and an upper end of the lifting column is configured to extend upward through the guiding column to protrude out of a top surface of the guiding column;
two ends of the transmission chain are fixed to a side surface of the lifting column; and
the transmission gear is engaged with the transmission chain.

5. The gantry-type slab transfer device according to claim 4, wherein the lifting mechanism further comprises a plurality of guiding wheel sets;
each of the plurality of guiding wheel sets is composed of two guiding wheels; the two guiding wheels are arranged spaced apart vertically, and are rotatably mounted on a second side surface of the guiding column; and
an outer peripheral surface of each of the two guiding wheels is configured to extend inward through an inner wall of the guiding column to be in frictional contact with a corresponding outer side surface of the lifting column.

6. The gantry-type slab transfer device according to claim 4, wherein an outer side surface of the lifting column is further provided with a plurality of limiting columns;
the plurality of limiting columns are provided adjacent to a top portion of the outer side surface of the lifting column, or adjacent to a bottom portion of the outer side surface of the lifting column;
the first side surface of the guiding column is provided with a plurality of limiting plates in one-to-one correspondence with the plurality of limiting columns;
the plurality of limiting plates are provided adjacent to a top portion of the first side surface of the guiding column, or adjacent to a bottom portion of the first side surface of the guiding column;
a surface of each of the plurality of limiting plates is configured to abut against a bottom surface or a top surface of a corresponding one among the plurality of limiting columns; and
those of the plurality of limiting columns located at the top portion of the outer side surface of the lifting column are provided adjacent to an upper end of the transmission chain, and those of the plurality of limiting columns located at the low portion of the outer side surface of the lifting column are provided adjacent to a lower end of the transmission chain.

7. The gantry-type slab transfer device according to claim 4, wherein the lifting mechanism further comprises at least two auxiliary gears;
the at least two auxiliary gears are mounted on a second side surface of the guiding column, and are adjacent to an upper portion or a lower portion of the transmission gear;
the at least two auxiliary gears are engaged with the transmission chain; and
the transmission gear is provided between the at least two auxiliary gears.
